(19) United States
(12) Patent Application Publication
(10) Pub. No.: US 2017/0310396 A1
(43) Pub. Date: Oct. 26, 2017

(54) COMMUNICATION DEVICE, COMMUNICATION METHOD, AND COMMUNICATION SYSTEM

(71) Applicant: FUJITSU LIMITED, Kawasaki-shi (JP)

(72) Inventor: Masanori Yoshizawa, Kawasaki (JP)

(73) Assignee: FUJITSU LIMITED, Kawasaki-shi (JP)

(21) Appl. No.: 15/467,997

(22) Filed: Mar. 23, 2017

(30) Foreign Application Priority Data
Apr. 21, 2016 (JP) 2016-085623

(51) Int. Cl. H04B 10/27; H04B 10/25

(52) U.S. Cl. CPC H04B 10/27; H04B 10/25

(57) ABSTRACT

A communication device includes a communication circuit configured to transmit, when detecting an interruption of communication performed via a first communication interface, information indicating the interruption of the communication, via a second communication interface; and a protection circuit configured to supply power to the communication circuit, when an interruption of power to be supplied to the communication circuit is detected, wherein, when the interruption of the power is detected, the communication circuit transmits information indicating the interruption of the power via the second communication interface, by using the power supplied from the protection circuit, and when the interruption of the power and the interruption of the communication are both detected, the communication circuit transmits the information indicating the interruption of the power, of the information indicating the interruption of the communication and the information indicating the interruption of the power, via the second communication interface.

### CROSS-REFERENCE TO RELATED APPLICATION

This application is based upon and claims the benefit of priority of the prior Japanese Patent Application No. 2016-085623, filed on Apr. 21, 2016, the entire contents of which are incorporated herein by reference.

### FIELD

The embodiment discussed herein is related to a communication device, a communication method, and a communication system.

### BACKGROUND

As one type of fiber-to-the-home (FTTH) optical communication systems, passive optical network (PON) systems have been known (see, for example, Japanese Laid-open Patent Publication No. 2011-103532 and Japanese National Publication of International Patent Application No. 2013-172404). There is also known a technique in which, when a power supply voltage falls below a predetermined level, warning information, which is outputted by a monitoring circuit that operates by receiving power supplied from a power circuit, is blocked at an AND circuit to prohibit collection of the warning information (see, for example, Japanese Laid-open Patent Publication No. 9-83615).

However, in the above-described related techniques, when power is interrupted in a large number of communication devices simultaneously due to, for example, a power outage, various notification messages are issued from the large number of communication devices to a monitoring device at a burst. This leads to a problem that in the monitoring device, some of information indicating a power interruption may be missed. It is desirable not to miss information indicating a power interruption, even when power interruptions occur in a large number of communication devices.

### SUMMARY

According to an aspect of the invention, a communication device includes a communication circuit configured to transmit, when detecting an interruption of communication performed via a first communication interface, information indicating the interruption of the communication, via a second communication interface; and a protection circuit configured to supply power to the communication circuit, when an interruption of power to be supplied to the communication circuit is detected, wherein, when the interruption of the power is detected, the communication circuit transmits information indicating the interruption of the power via the second communication interface, by using the power supplied from the protection circuit, and when the interruption of the power and the interruption of the communication are both detected, the communication circuit transmits the information indicating the interruption of the power, of the information indicating the interruption of the communication and the information indicating the interruption of the power, via the second communication interface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication system according to an embodiment;

FIG. 2 is a diagram illustrating an example of an ONU device according to the embodiment;

FIG. 3 is a diagram illustrating an example of a protection circuit of the ONU device according to the embodiment;

FIG. 4 is a diagram illustrating an example of a MAC_LSI of the ONU device according to the embodiment;

FIG. 5 is a diagram illustrating an example of each of a PON interface card and a control interface card of an OLT device according to the embodiment;

FIG. 6 is a sequence diagram illustrating an example of processing of transmitting an OAM frame at an ONU-device power interruption in the communication system according to the embodiment;

FIG. 7 is a diagram illustrating a change in voltage of each section at an ONU-device power interruption in the ONU device according to the embodiment;

FIG. 8 is a flowchart illustrating an example of processing of issuing a dying gasp OAM frame performed by the ONU device according to the embodiment;

FIG. 9 is a flowchart illustrating an example of processing of issuing an event notification OAM frame performed by the ONU device according to the embodiment;

FIG. 10 is a diagram illustrating an example of an OAM frame transmitted by the ONU device according to the embodiment;

FIG. 11 is a diagram illustrating an example of a Flags field of the OAM frame transmitted by the ONU device according to the embodiment; and

FIG. 12 is a diagram illustrating an example of a Code field of the OAM frame transmitted by the ONU device according to the embodiment.

### DESCRIPTION OF EMBODIMENT

Hereinafter, a communication device, a communication system, and a communication method according to an embodiment will be described with reference to accompanying drawings.

### Embodiment

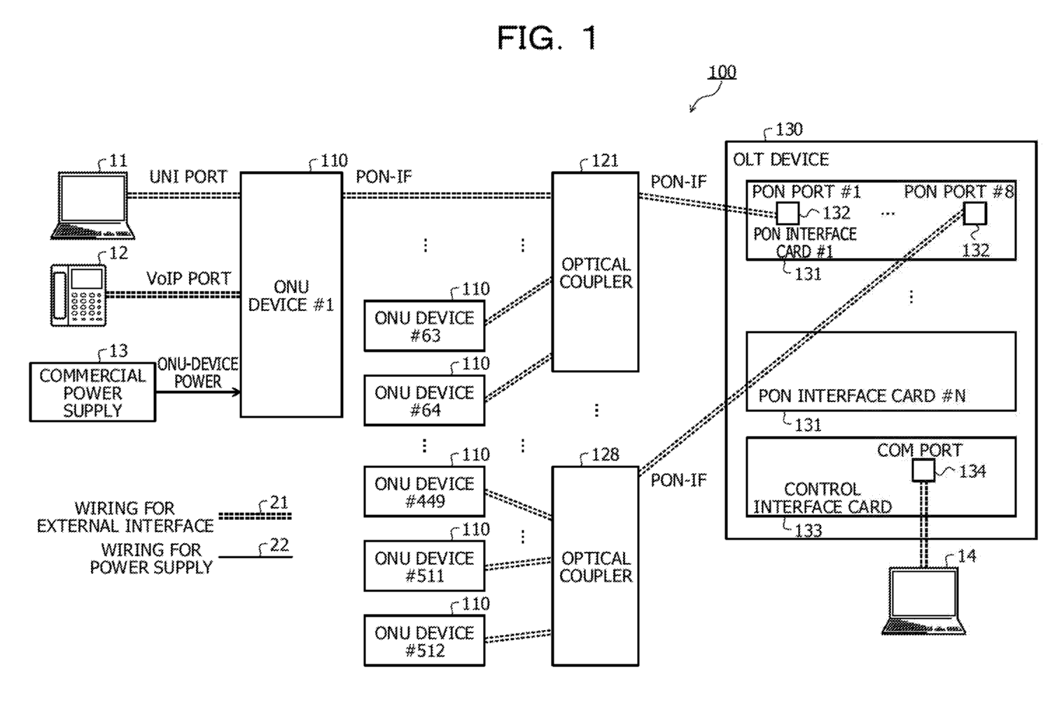

FIG. 1 is a diagram illustrating an example of the communication system according to the embodiment. In FIG. 1, a dashed line 21 indicates wiring with an external interface, and a solid line 22 indicates wiring for power supply. A communication system 100 according to the embodiment is a PON system including 512 ONU devices 110 (#1 to #512), optical couplers 121 to 128, and an OLT device 130, as illustrated in FIG. 1. ONU stands for Optical Network Unit (a subscriber-side terminal). OLT stands for Optical Line Terminal (a central office-side terminal). The communication system 100 is, for example, a 10GE-PON with a transmission rate of 10 [Gbps]. 10GE-PON stands for 10 Gigabit Ethernet-PON. Ethernet is a registered trademark.

The number of the ONU devices 110 illustrated in FIG. 1 and the number of the optical couplers are each a mere example. The number of the ONU devices 110 and the number of the optical couplers may be any number. The communication system 100 is not limited to the 10GE-PON. The communication system 100 may be any of various passive optical network (PON) systems such as a GE-PON with a transmission rate of 1 [Gbps].

Next, the ONU device 110 (#1) among the ONU devices 110 (#1 to #512) will be described. The ONU devices 110 (#2 to #512) may each be configured as with the ONU device 110 (#1). The ONU device 110 (#1) is connected to the OLT device 130 via the optical coupler 121. In the example illustrated in FIG. 1, the ONU device 110 (#1) is connected to a PON port 132 (#1) of a PON interface card 131 (#1) of the OLT device 130, via the optical coupler 121.

To a user network interface (UNI) port of the ONU device 110 (#1), a personal computer 11 is connected. To a voice over internet protocol (VoIP) port of the ONU device 110 (#1), a VoIP telephone 12 is connected. To the ONU device 110 (#1), a commercial power supply 13 is connected. The commercial power supply 13 supplies ONU-device power to the ONU device 110 (#1). The ONU device 110 (#1) operates using the ONU-device power supplied from the commercial power supply 13.

The ONU device 110 (#1) converts a signal (an electric signal) transmitted from each of the personal computer 11 and the VoIP telephone 12 into an optical signal. The ONU device 110 (#1) then transmits the optical signal obtained by the conversion, to the PON interface card 131 (#1) of the OLT device 130, via the optical coupler 121. The ONU device 110 (#1) receives an optical signal transmitted from the PON interface card 131 (#1) of the OLT device 130. The ONU device 110 (#1) then transmits a signal (an electric signal) obtained from the received optical signal, to each of the personal computer 11 and the VoIP telephone 12.

The ONU side of the optical coupler 121 is connected to each of the sixty-four ONU devices 110 (#1 to #64) via a PON interface (PON-IF). Similarly, the ONU side of each of the optical couplers 122 to 128 is connected to each of the sixty-four ONU devices 110 via a PON interface (PON-IF).

The OLT side of the optical coupler 121 is connected to the PON port 132 (#1) of the PON interface card 131 (#1) of the OLT device 130 via a PON interface (PON-IF). Similarly, the OLT side of each of the optical couplers 122 to 128 is connected to the corresponding one of the PON ports 132 (#2 to #8) of the PON interface card 131 (#1) of the OLT device 130 via a PON interface (PON-IF).

The OLT device 130 includes an N (N: a natural number of 1 or greater) number of the PON interface cards 131 (#1 to #N), and a control interface card 133. The PON interface card 131 (#1) will be described, but the same applies to the remaining PON interface cards 131 (#2 to #N).

The PON interface card 131 (#1) is an optical communication device that performs optical communication with the ONU devices 110 (#1 to #512) connected to the optical couplers 121 to 128. The PON interface card 131 (#1) includes the 8 PON ports 132 (#1 to #8). The PON ports 132 (#1 to #8) are connected to the optical couplers 121 to 128, respectively. For example, the PON interface card 131 (#1) performs optical communication with the ONU devices 110 (#1 to #64) by using the PON port 132 (#1).

The control interface card 133 is a control interface between the PON interface cards 131 (#1 to #N) and an apparatus outside the OLT device 130, and has a communication port (COM) port 134. For example, connecting a personal computer 14 of a system administrator to the COM port 134 enables input and output of information between the personal computer 14 and the PON interface cards 131 (#1 to #N).

The technology is applicable to transmission of OAM frames from the ONU devices 110 (#1 to #512) to the OLT device 130, when interruptions of the ONU-device power (a power interruption) occur in the ONU devices 110 (#1 to #512) simultaneously due to a cause such as a power outage. OAM stands for Operation Administration Maintenance (a maintenance management function). However, the technology may not be applied to all of the ONU devices 110 (#1 to #512). The technology may be applied to some of the ONU devices 110 (#1 to #512).

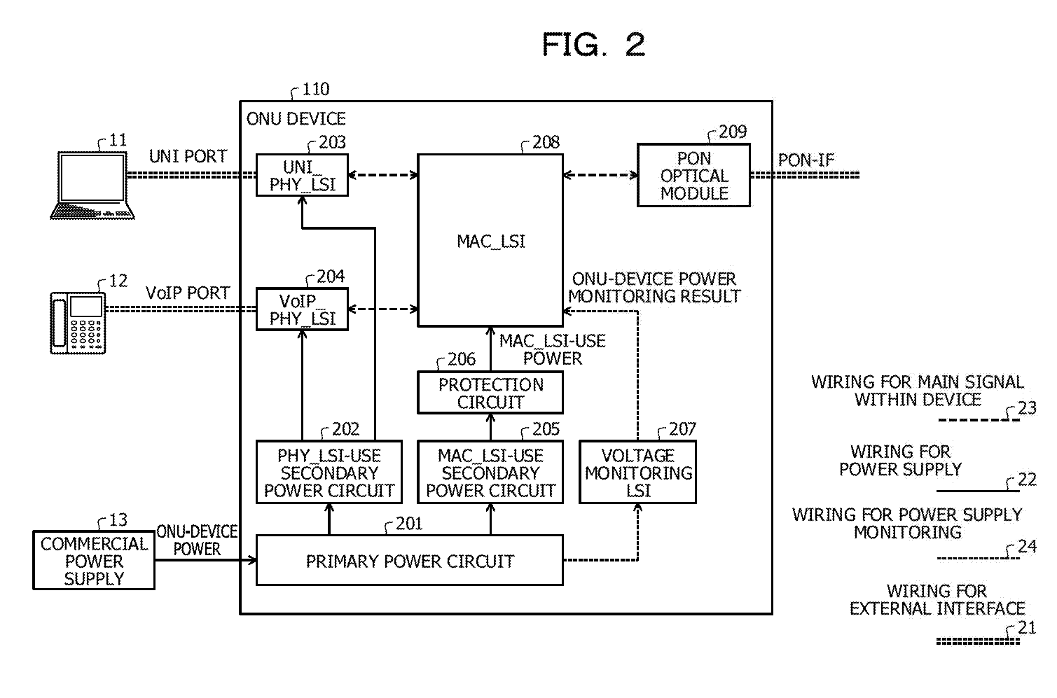

FIG. 2 is a diagram illustrating an example of the ONU device according to the embodiment. In FIG. 2, parts similar to those illustrated in FIG. 1 are provided with the same reference characters as those illustrated in FIG. 1, and will not be described. In FIG. 2, a dashed line 23 indicates wiring for a main signal (user data) within the device. A dashed line 24 indicates wiring for power-supply monitoring. At least one of the ONU devices 110 (#1 to #512) illustrated in FIG. 1 may be implemented by the ONU device 110 illustrated in FIG. 2, for example.

The ONU device 110 illustrated in FIG. 2 includes a primary power circuit 201, a PHY_LSI-use secondary power circuit 202, a UNI_PHY_LSI 203, and a VoIP_PHY_LSI 204. The ONU device 110 illustrated in FIG. 2 further includes a MAC_LSI-use secondary power circuit 205, a protection circuit 206, a voltage monitoring LSI 207, a MAC_LSI 208, and a PON optical module 209. MAC stands for Media Access Control. LSI stands for Large Scale Integration.

The primary power circuit 201 performs voltage conversion of ONU-device power supplied from the commercial power supply 13. The primary power circuit 201 supplies power obtained by the voltage conversion, to the PHY_LSI-use secondary power circuit 202 and the MAC_LSI-use secondary power circuit 205. The PHY_LSI-use secondary power circuit 202 performs voltage conversion of the power supplied from the primary power circuit 201. The PHY_LSI-use secondary power circuit 202 then supplies power obtained by the voltage conversion, to the UNI_PHY_LSI 203 and the VoIP_PHY_LSI 204.

The UNI_PHY_LSI 203 is a communication interface (a transmitter) connected to the personal computer 11 via a UNI port of the ONU device 110. For example, the UNI_PHY_LSI 203 performs physical layer (PHY layer) processing for an uplink signal (an electric signal) transmitted from the personal computer 11. The UNI_PHY_LSI 203 then outputs the uplink signal after the physical layer processing, to the MAC_LSI 208. The UNI_PHY_LSI 203 performs physical layer processing for a downlink signal (an electric signal) outputted from the MAC_LSI 208. The UNI_PHY_LSI 203 then transmits the downlink signal after the physical layer processing, to the personal computer 11. The UNI_PHY_LSI 203 operates using the power supplied from the PHY_LSI-use secondary power circuit 202.

The VoIP_PHY_LSI 204 is a communication interface (a transmitter) connected to the VoIP telephone 12 via a VoIP port of the ONU device 110. For example, the VoIP_PHY_LSI 204 performs physical layer processing for an uplink signal (an electric voice signal) transmitted from the VoIP telephone 12. The VoIP_PHY_LSI 204 then outputs the uplink signal after the physical layer processing, to the MAC_LSI 208. The VoIP_PHY_LSI 204 performs physical layer processing for a downlink signal (an electric voice signal) outputted from the MAC_LSI 208. The VoIP_PHY_LSI 204 then transmits the downlink signal after the physical layer processing, to the VoIP telephone 12. The VoIP_PHY_LSI 204 operates using the power supplied from the PHY_LSI-use secondary power circuit 202.

The MAC_LSI-use secondary power circuit 205 performs voltage conversion to convert power supplied from the primary power circuit 201 into an operation voltage of the MAC_LSI 208. The MAC_LSI-use secondary power circuit 205 then supplies power obtained by the voltage conversion, to the MAC_LSI 208 via the protection circuit 206, as MAC_LSI-use power.

The protection circuit 206 is a protection circuit that protects the MAC_LSI 208 by evading a sudden interruption of the MAC_LSI-use power supplied to the MAC_LSI 208, when an interruption of the MAC_LSI-use power supplied from the MAC_LSI-use secondary power circuit 205 occurs. The interruption of the MAC_LSI-use power supplied from the MAC_LSI-use secondary power circuit 205 is caused by, for example, an interruption of the ONU-device power supplied from the commercial power supply 13 to the ONU device 110.

Owing to the protection circuit 206, the MAC_LSI 208 may issue a dying gasp, which is a power interruption notification, to the OLT side, when, for example, an interruption of the ONU-device power supplied from the commercial power supply 13 to the ONU device 110 occurs. The dying gasp is, for example, a control signal used for notification of an unrecoverable state such as a power outage.

The voltage monitoring LSI 207 is a detection section that detects an interruption of the ONU-device power supplied from the commercial power supply 13 to the ONU device 110, by monitoring an output voltage of the primary power circuit 201. For example, the voltage monitoring LSI 207 may monitor a voltage of the ONU-device power, by receiving power that branches from the power outputted from the primary power circuit 201 to the MAC_LSI-use secondary power circuit 205. Alternatively, the voltage monitoring LSI 207 may monitor the voltage of the ONU-device power, by receiving power that branches from power outputted from the MAC_LSI-use secondary power circuit 205 to the protection circuit 206.

When the output voltage of the primary power circuit 201 falls below a predetermined threshold, the voltage monitoring LSI 207 determines that an interruption of the ONU-device power has occurred. The voltage monitoring LSI 207 then outputs an ONU-device power monitoring result, which indicates the occurrence of the interruption of the ONU-device power, to the MAC_LSI 208. Alternatively, the voltage monitoring LSI 207 outputs the output voltage of the primary power circuit 201 to the MAC_LSI 208, as the ONU-device power monitoring result. Detection of an interruption of the ONU-device power based on a comparison between the output voltage of the primary power circuit 201 and the threshold may be executed in the MAC_LSI 208.

The MAC_LSI 208 communicates with the personal computer 11 and the VoIP telephone 12 (communication devices) connected to the ONU device 110, via the UNI_PHY_LSI 203 and the VoIP_PHY_LSI 204 (communication interfaces), respectively.

For example, the MAC_LSI 208 performs MAC layer processing for an uplink signal outputted from each of the UNI_PHY_LSI 203 and the VoIP_PHY_LSI 204. The MAC_LSI 208 then outputs each of these uplink signals after the MAC layer processing, to the PON optical module 209. The MAC_LSI 208 performs MAC layer processing for a downlink signal outputted from the PON optical module 209. The MAC_LSI 208 then outputs the downlink signal after the MAC layer processing, to the UNI_PHY_LSI 203 or the VoIP_PHY_LSI 204, according to an address of the downlink signal.

The MAC_LSI 208 detects a link interruption of the UNI port, based on an interruption of signal input from the UNI_PHY_LSI 203. When detecting a link interruption of the UNI port, the MAC_LSI 208 outputs an event notification OAM frame for notification of a UNI-port-link interruption, to the PON optical module 209.

The MAC_LSI 208 detects a link interruption of the VoIP port, based on an interruption of signal input from the VoIP_PHY_LSI 204. When detecting a link interruption of the VoIP port, the MAC_LSI 208 outputs an event notification OAM frame for notification of a VoIP-port-link interruption, to the PON optical module 209.

The MAC_LSI 208 determines whether there is an interruption of the ONU-device power, based on the ONU-device power monitoring result outputted from the voltage monitoring LSI 207. When an interruption of the ONU-device power occurs, the MAC_LSI 208 outputs a dying gasp OAM frame for notification of the interruption of the ONU-device power, to the PON optical module 209.

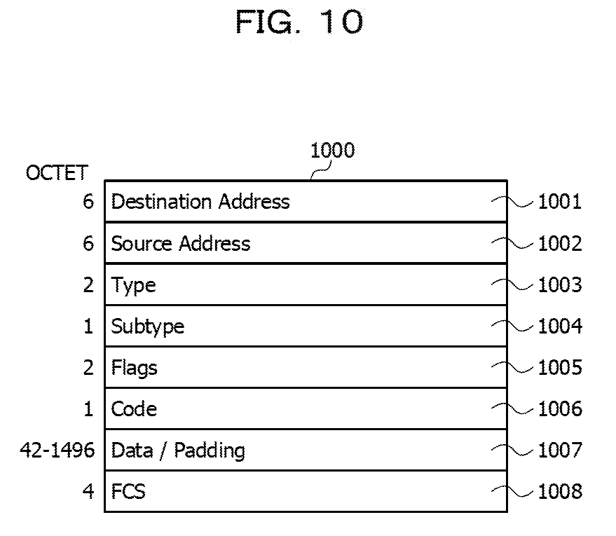

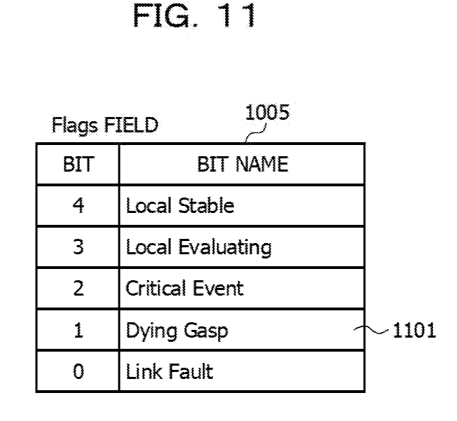

The dying gasp OAM frame is an information OAM frame that assumes a value of a predetermined bit region (Dying Gasp) to be “1”. The predetermined bit region (Dying Gasp) will be described later (with reference to FIGS. 10 and 11).

The PON optical module 209 converts each of an uplink signal and an OAM frame outputted from the MAC_LSI 208 into an optical signal, and transmits the optical signal after the conversion, via a PON interface (PON-IF). The optical signal transmitted from the PON optical module 209 is received by the OLT device 130, via the optical coupler, to which the ONU device 110 is connected, among the optical couplers 121 to 128.

The PON optical module 209 converts a downlink optical signal, which is transmitted from the OLT device 130 via the optical coupler to which the ONU device 110 is connected among the optical couplers 121 to 128, into an electric signal. The PON optical module 209 then outputs the downlink signal converted into the electric signal, to the MAC_LSI 208.

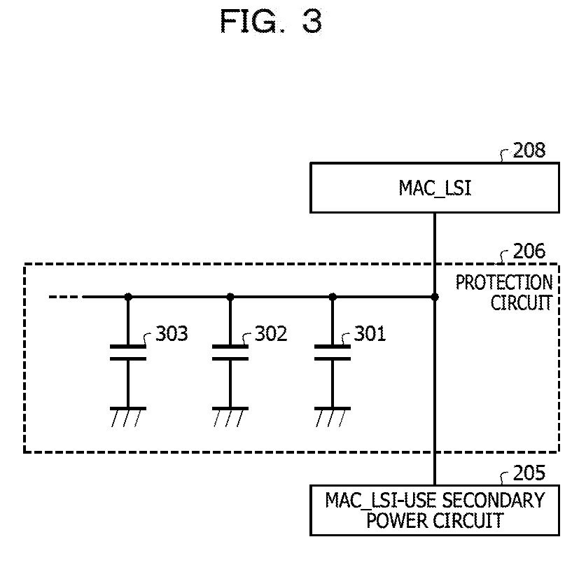

FIG. 3 is a diagram illustrating an example of the protection circuit of the ONU device according to the embodiment. In FIG. 3, parts similar to those illustrated in FIG. 2 are provided with the same reference characters as those illustrated in FIG. 2, and will not be described. The protection circuit 206 illustrated in FIG. 2 may be implemented by, for example, large-capacitance capacitors 301 to 303 and so on connected in parallel to power-supply wiring between the MAC_LSI-use secondary power circuit 205 and the MAC_LSI 208, as illustrated in FIG. 3. However, the configuration of the protection circuit 206 is not limited to this example. Any of various circuits may be employed, if the circuit is capable of temporarily protecting the MAC_LSI-use power supplied to the MAC_LSI 208 against an interruption of the ONU-device power supplied from the commercial power supply 13 to the ONU device 110.

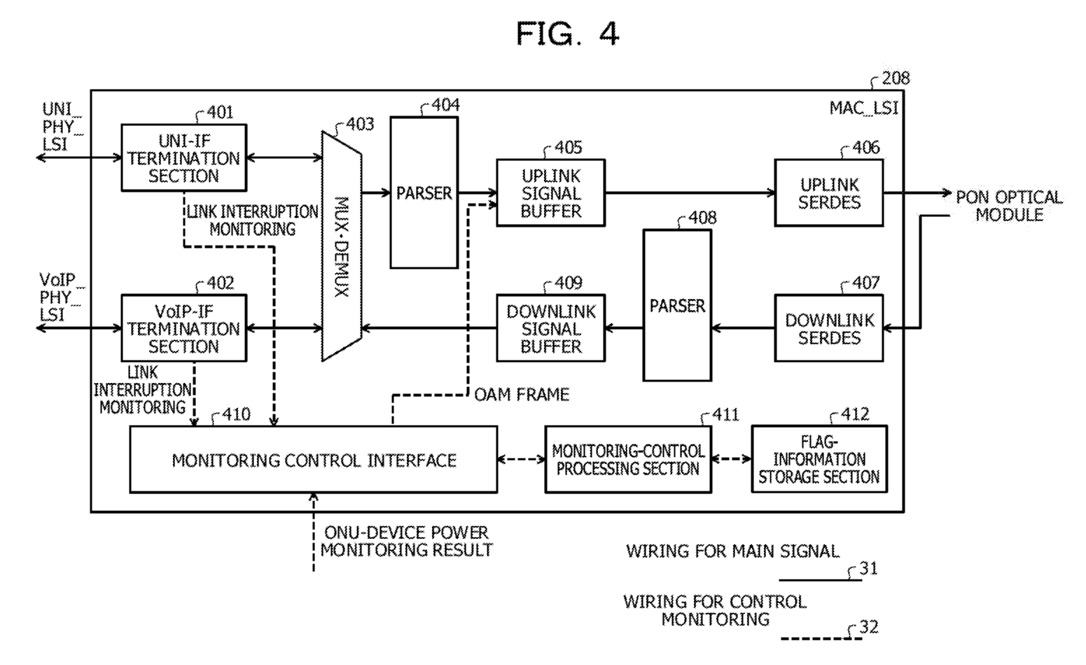

FIG. 4 is a diagram illustrating an example of the MAC_LSI of the ONU device according to the embodiment. In FIG. 4, a solid line 31 indicates wiring for a main signal. A dashed line 32 indicates wiring for control monitoring. The MAC_LSI 208 illustrated in FIG. 2 includes, for example, a UNI-IF termination section 401, a VoIP-IF termination section 402, a MUX-DEMUX 403, a parser 404, an uplink signal buffer 405, and an uplink SERDES 406, as illustrated in FIG. 4. The MAC_LSI 208 further includes a downlink SERDES 407, a parser 408, a downlink signal buffer 409, a monitoring control interface 410, a monitoring-control processing section 411, and a flag-information storage section 412. SERDES stands for SERializer/DESerializer. MUX stands for Multiplexer (a multiplexer). DEMUX stands for deMultiplexer (a demultiplexer).

The UNI-IF termination section 401 terminates a UNI interface with the UNI_PHY_LSI 203 illustrated in FIG. 2. For example, the UNI-IF termination section 401 outputs an uplink signal received from the UNI_PHY_LSI 203, to the MUX-DEMUX 403. The UNI-IF termination section 401 outputs a downlink signal received from the MUX-DEMUX 403, to the UNI_PHY_LSI 203.

The VoIP-IF termination section 402 terminates a VoIP interface with the VoIP_PHY_LSI 204 illustrated in FIG. 2. For example, the VoIP-IF termination section 402 outputs an uplink signal received from the VoIP_PHY_LSI 204, to the MUX-DEMUX 403. The VoIP-IF termination section 402 outputs a downlink signal received from the MUX-DEMUX 403, to the VoIP_PHY_LSI 204.

The MUX-DEMUX 403 performs multiplexing (MUX) of an uplink signal outputted from each of the UNI-IF termination section 401 and the VoIP-IF termination section 402. The MUX-DEMUX 403 then outputs the multiplexed uplink signal to the parser 404. The MUX-DEMUX 403 reads a downlink signal stored in the downlink signal buffer 409. The MUX-DEMUX 403 then outputs the read downlink signal, to the UNI-IF termination section 401 or the VoIP-IF termination section 402, according to an address.

The parser 404 determines an uplink signal to be transmitted to the PON interface card 131, among signals (for example, packets) outputted from the MUX-DEMUX 403. The parser 404 then stores the determined uplink signal into the uplink signal buffer 405. The parser 404 does not store an uplink signal, which is not to be transmitted to the PON interface card 131, such as a control signal addressed to the ONU device 110, among the signals outputted from the MUX-DEMUX 403, into the uplink signal buffer 405.

The uplink SERDES 406 reads an uplink signal (a main signal or a control signal) stored in the uplink signal buffer 405. The uplink SERDES 406 converts the read uplink signal, from parallel data to serial data. The uplink SERDES 406 then outputs the uplink signal converted to the serial data, to the PON optical module 209 illustrated in FIG. 2.

For example, the MAC_LSI 208 reads each piece of information (an uplink signal) stored in the uplink signal buffer 405 at a timing specified by the PON interface card 131, and outputs the read piece of information from the uplink SERDES 406 to the PON optical module 209. The timing specified by the PON interface card 131 is an uplink-signal transmission timing assigned to the ONU device itself among the ONU devices connected to the PON interface card 131

The downlink SERDES 407 converts a downlink signal outputted from the PON optical module 209, from serial data to parallel data. The downlink SERDES 407 then outputs the downlink signal converted to the parallel data, to the parser 408.

The parser 408 determines a downlink signal to be transmitted to the personal computer 11 or the VoIP telephone 12, among downlink signals (for example, packets) outputted from the downlink SERDES 407. The parser 408 then stores the determined downlink signal into the downlink signal buffer 409. The parser 408 does not store a downlink signal, which is not to be transmitted to the personal computer 11 or the VoIP telephone 12 such as a control signal addressed to the ONU device 110, among the downlink signals outputted from the downlink SERDES 407, into the downlink signal buffer 409.

The monitoring-control processing section 411 monitors the UNI-IF termination section 401 and the VoIP-IF termination section 402, via the monitoring control interface 410. In addition, the monitoring-control processing section 411 monitors interruptions of links to the UNI_PHY_LSI 203 and the VoIP_PHY_LSI 204, based on results of monitoring the UNI-IF termination section 401 and the VoIP-IF termination section 402 (link interruption monitoring).

When detecting an interruption of the link to the UNI_PHY_LSI 203, the monitoring-control processing section 411 generates an event notification OAM frame for notification of a UNI-port-link interruption. When detecting an interruption of the link to the VoIP_PHY_LSI 204, the monitoring-control processing section 411 generates an event notification OAM frame for notification of a VoIP-port-link interruption.

The monitoring-control processing section 411 then stores the generated event notification OAM frame into the uplink signal buffer 405, via the monitoring control interface 410, as an uplink signal. However, when flag information indicating transmission of a dying gasp OAM frame is stored in the flag-information storage section 412, the monitoring-control processing section 411 does not store the event notification OAM frame into the uplink signal buffer 405.

The monitoring-control processing section 411 determines whether there is an interruption of the ONU-device power, based on an ONU-device power monitoring result outputted from the voltage monitoring LSI 207 illustrated in FIG. 2. When an interruption of the ONU-device power occurs, the monitoring-control processing section 411 generates a dying gasp OAM frame for notification of the interruption of the ONU-device power. The monitoring-control processing section 411 then stores the generated dying gasp OAM frame into the uplink signal buffer 405, via the monitoring control interface 410, as an uplink signal.

When an interruption of the ONU-device power occurs, the monitoring-control processing section 411 causes the flag-information storage section 412 to store detection of the interruption of the ONU-device power, namely, flag information indicating transmission of a dying gasp OAM frame. The flag-information storage section 412 is a memory that stores flag information.

When an interruption of the ONU-device power occurs, if an event notification OAM frame is stored in the uplink signal buffer 405 at that moment, the monitoring-control processing section 411 may discard this event notification OAM frame. This may avoid transmission of an event notification OAM frame for notification of a port-link interruption that has occurred before occurrence of an interruption of the ONU-device power. Therefore, missing of a dying gasp OAM frame, which may occur due to prohibition of transmission of the dying gasp OAM frame during a waiting time for transmission of an event notification OAM frame, may be avoided.

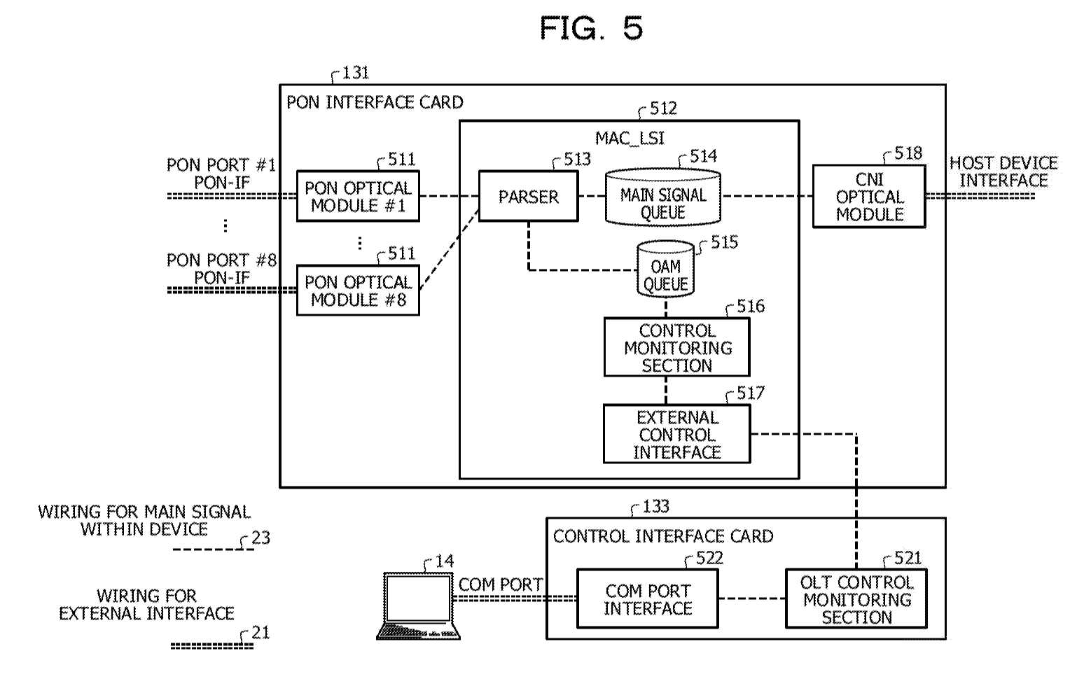

FIG. 5 is a diagram illustrating an example of each of the PON interface card and the control interface card of the OLT device according to the embodiment. Each of the PON interface cards 131 (#1 to #N) of the OLT device 130 illustrated in FIG. 1 may be implemented by, for example, the PON interface card 131 illustrated in FIG. 5. Among processing sections of the PON interface card 131, a processing section for an uplink signal will be described with reference to FIG. 5.

The PON interface card 131 illustrated in FIG. 5 includes 8 PON optical modules 511 (#1 to #8), a MAC_LSI 512, and a CNI optical module 518. CNI stands for Core Network Interface.

The PON optical modules 511 (#1 to #8) each convert an optical signal inputted from the corresponding one of the PON ports 132 (#1 to #8) illustrated in FIG. 1 into an electric signal. The PON optical modules 511 (#1 to #8) then each output an uplink signal, which is the electric signal resulting from the conversion, to the MAC_LSI 512.

The MAC_LSI 512 includes a parser 513, a main signal queue 514, an OAM queue 515, a control monitoring section 516, and an external control interface 517.

The parser 513 determines whether the uplink signal outputted from each of the PON optical modules 511 (#1 to #8) is a main signal or a control signal. The control signal is, for example, an OAM frame. The parser 513 stores the uplink signal determined to be the main signal, into the main signal queue 514. The parser 513 stores the uplink signal determined to be the OAM frame (a control signal), into the OAM queue 515.

OAM is a slow protocol. Therefore, for example, the OAM queue 515 is set to have a small capacity, as compared with the main signal queue 514. For this reason, when, for example, OAM frames are transmitted from many of the ONU devices 110 to the PON interface card 131 at a burst, an overflow of OAM frames stored in the OAM queue 515 may easily occur.

The control monitoring section 516 performs control monitoring of the OAM frame stored in the OAM queue 515. For example, the control monitoring section 516 receives an instruction to read information of an OAM frame, from the control interface card 133, via the external control interface 517.

When receiving an instruction to read information of an OAM frame, the control monitoring section 516 reads the applicable OAM frame among the OAM frames stored in the OAM queue 515. Next, the control monitoring section 516 generates notification information usable by the system administrator based on the read OAM frame. The control monitoring section 516 then transmits the generated notification information to the control interface card 133 via the external control interface 517.

The control interface card 133 illustrated in FIG. 1 includes, for example, an OLT control monitoring section 521 and a COM port interface 522, as illustrated in FIG. 5. The OLT control monitoring section 521 performs control monitoring of the PON interface card 131, under control of the personal computer 14 performed via the COM port interface 522.

For example, the OLT control monitoring section 521 issues an instruction to read information of an OAM frame, to the control monitoring section 516, via the external control interface 517 of the MAC_LSI 512. The OLT control monitoring section 521 acquires notification information, which is outputted from the control monitoring section 516 via the external control interface 517 in response to the instruction to read the information of the OAM frame. The OLT control monitoring section 521 then transmits the acquired notification information to the personal computer 14 via the COM port interface 522.

The COM port interface 522 is an interface between the personal computer 14 connected to the COM port 134 illustrated in FIG. 1 and the control interface card 133.

The personal computer 14 instructs the OLT control monitoring section 521 to read information of an OAM frame, via the COM port interface 522. When notification information based on the OAM frame is received from the OLT control monitoring section 521 via the COM port interface 522, the personal computer 14 outputs the notification information to a user (the system administrator) of the personal computer 14.

The CNI optical module 518 reads an uplink signal stored in the main signal queue 514 of the MAC_LSI 512. The CNI optical module 518 then converts the read uplink signal into an optical signal. The CNI optical module 518 subsequently transmits the converted uplink signal, to a host device, via a host device interface. The host device is a device of a core network to which the OLT device 130 is connected.

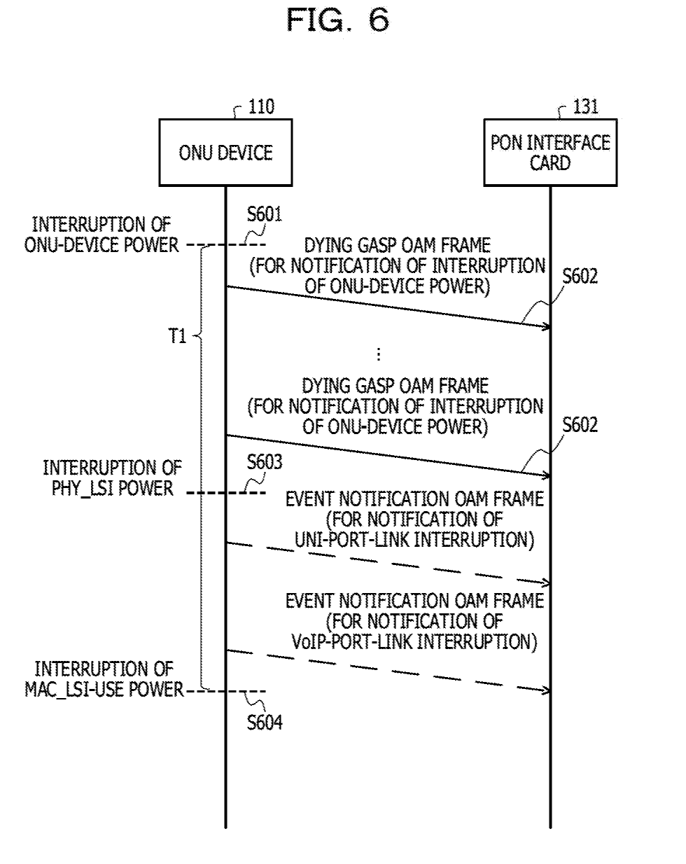

FIG. 6 is a sequence diagram illustrating an example of processing of transmitting the OAM frame at an ONU-device power interruption in the communication system according to the embodiment. When an interruption of the ONU-device power supplied from the commercial power supply 13 illustrated in FIG. 1 to the ONU device 110 occurs, each step of processing illustrated in FIG. 6, for example, is executed in the communication system 100. First, an interruption of the ONU-device power supplied from the commercial power supply 13 to the ONU device 110 occurs (S601). The ONU device 110 detects the interruption of the ONU-device power occurring in S601. This detection of the interruption of the ONU-device power is executed by, for example, the voltage monitoring LSI 207 illustrated in FIG. 2.

Next, the ONU device 110 starts repeated transmissions of a dying gasp OAM frame for notification of the interruption of the ONU-device power, to the PON interface card 131 (S602). The transmission of the dying gasp OAM frame in S602 is executed by, for example, the MAC_LSI 208 illustrated in FIG. 2.

Next, an interruption of PHY_LSI power supplied from the PHY_LSI-use secondary power circuit 202 to the UNI_PHY_LSI 203 and the VoIP_PHY_LSI 204 occurs (S603). This interruption of the PHY_LSI power occurs due to the interruption of the ONU-device power in S601. This interruption of the PHY_LSI power stops operation of the UNI_PHY_LSI 203 and the VoIP_PHY_LSI 204. A port-link interruption then occurs in each of the UNI_PHY_LSI 203 and the VoIP_PHY_LSI 204.

The ONU device 110 detects this port-link interruption in each of the UNI_PHY_LSI 203 and the VoIP_PHY_LSI 204. This detection of the port-link interruption is executed by detection of an interruption of signal input from each of the UNI_PHY_LSI 203 and the VoIP_PHY_LSI 204 by the MAC_LSI 208.

However, the ONU device 110 does not transmit an event notification OAM frame for notification of a UNI-port-link interruption in the UNI_PHY_LSI 203, to the PON interface card 131. The ONU device 110 does not transmit an event notification OAM frame for notification of a VoIP-port-link interruption in the VoIP_PHY_LSI 204, to the PON interface card 131.

This is because the interruption of the ONU-device power has higher priority as an event than those of the UNI-port-link interruption and the VoIP-port-link interruption, and the ONU device 110 transmits the dying gasp OAM frame for notification of the interruption of the ONU-device power in S602. In other words, when transmitting the dying gasp OAM frame for notification of the interruption of the ONU-device power, the ONU device 110 does not transmit the event notification OAM frame for notification of the UNI-port-link interruption or the VoIP-port-link interruption.

Next, due to the interruption of the ONU-device power in S601, an interruption of the MAC_LSI-use power supplied to the MAC_LSI 208 occurs (S604). During a period T1 from S601 to S604, the MAC_LSI-use power supplied to the MAC_LSI 208 is maintained by the capacitors 301 to 303 and so on of the protection circuit 206. In this way, the protection circuit 206 allows the interruption of the MAC_LSI-use power supplied to the MAC_LSI 208 to occur after the port-link interruption in each of the UNI_PHY_LSI 203 and the VoIP_PHY_LSI 204.

As illustrated in FIG. 6, when transmitting a dying gasp OAM frame for notification of an interruption of the ONU-device power, the ONU device 110 does not transmit an event notification OAM frame. This may suppress transmission of excessive event notification OAM frames.

Therefore, even when interruptions of the ONU-device power simultaneously occur in the large number of ONU devices 110 due to, for example, a power outage, issuance of event notification OAM frames from the large number of ONU devices 110 to the OLT device 130 at a burst may be avoided. Hence, in the OAM queue 515 of the OLT device 130, discard of a dying gasp OAM frame due to an overflow of OAM frames may be avoided.

For the system administrator, as for analysis of a cause of a failure, an event notification OAM frame for notification of a UNI-port-link interruption or a VoIP-port-link interruption is information that may not be used, if a dying gasp OAM frame is acquired. Therefore, even when a configuration of not transmitting an event notification OAM frame when transmitting a dying gasp OAM frame is provided, an influence on the analysis of the cause of the failure is small.

For example, assume that when a failure of communication in the PON interface card 131 occurs, event notification OAM frames are transmitted at a burst, and a dying gasp OAM frame is missed. In this case, for example, it is difficult for the system administrator to distinguish whether the cause of the failure of the communication in the PON interface card 131 is a PON-IF optical fiber interruption or an ONU device power interruption. In contrast, if acquisition of a dying gasp OAM frame is allowed, the system administrator may determine that there is occurrence of an ONU device power interruption, by distinguishing this interruption from others such as a PON-IF optical fiber interruption.

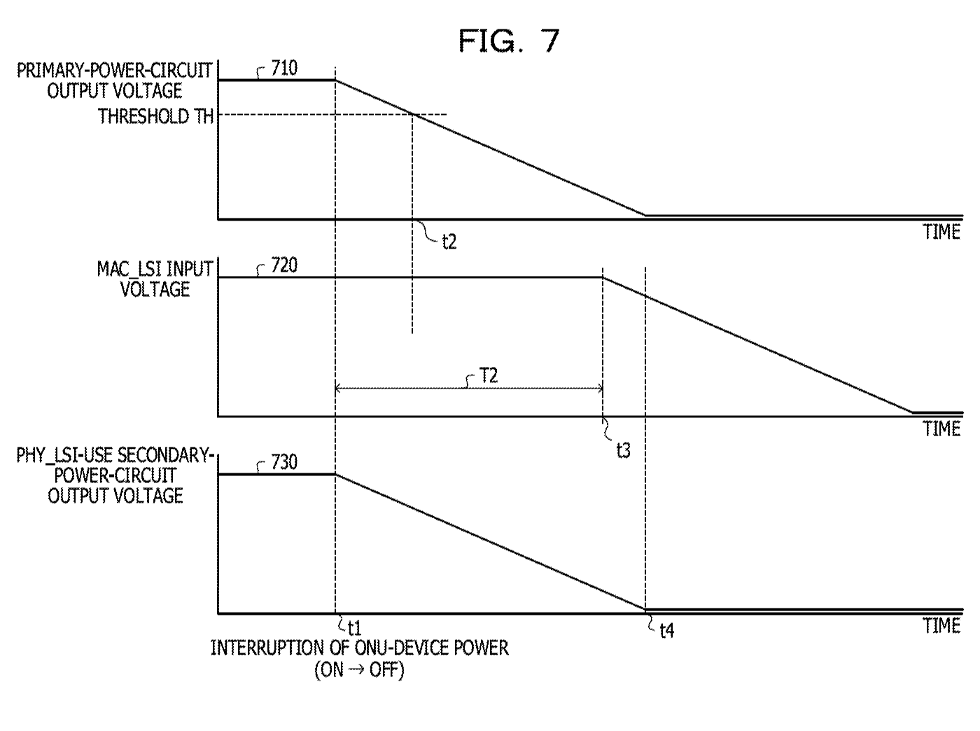

FIG. 7 is a diagram illustrating a change in voltage of each section at an ONU-device power interruption in the ONU device according to the embodiment. In FIG. 7, a horizontal axis indicates time. A primary-power-circuit output voltage 710 indicates a voltage of power supplied from the primary power circuit 201 to the PHY_LSI-use secondary power circuit 202 illustrated in FIG. 2, that is monitored by the voltage monitoring LSI 207.

A MAC_LSI input voltage 720 indicates a voltage of the MAC_LSI-use power input into the MAC_LSI 208. A PHY_LSI-use secondary-power-circuit output voltage 730 indicates a voltage of power supplied from the PHY_LSI-use secondary power circuit 202 to the UNI_PHY_LSI 203 and the VoIP_PHY_LSI 204 illustrated in FIG. 2.

Assume that an interruption of the ONU-device power (ON OFF) occurs at a time t1 in the horizontal axis. In this case, the primary-power-circuit output voltage 710 and the PHY_LSI-use secondary-power-circuit output voltage 730 each start decreasing at the time t1 and become approximately 0 [V] at a time t4. Meanwhile, the MAC_LSI input voltage 720 is kept from decreasing by the protection circuit 206 before a time t3, and starts decreasing at the time t3. A period from the time t1 to the time t3 is a voltage-drop protection period T2 during which the protection circuit 206 maintains the voltage of the MAC_LSI-use power input into the MAC_LSI 208.

A threshold TH is a threshold used by the voltage monitoring LSI 207 illustrated in FIG. 2 to monitor the primary-power-circuit output voltage 710. The voltage monitoring LSI 207 detects an interruption of the ONU-device power, when the primary-power-circuit output voltage 710 falls below the threshold TH at a time t2 after decreasing from the time t1. In this case, the MAC_LSI 208 transmits a dying gasp OAM frame to the PON interface card 131 during a period from the time t2 to the time t3.

At the time t4 when the PHY_LSI-use secondary-power-circuit output voltage 730 is approximately 0 [V], the MAC_LSI 208 detects a UNI-port-link interruption or a VoIP-port-link interruption. However, since the MAC_LSI 208 transmits the dying gasp OAM frame, the MAC_LSI 208 does not transmit an event notification OAM frame for notification of the UNI-port-link interruption or the VoIP-port-link interruption.

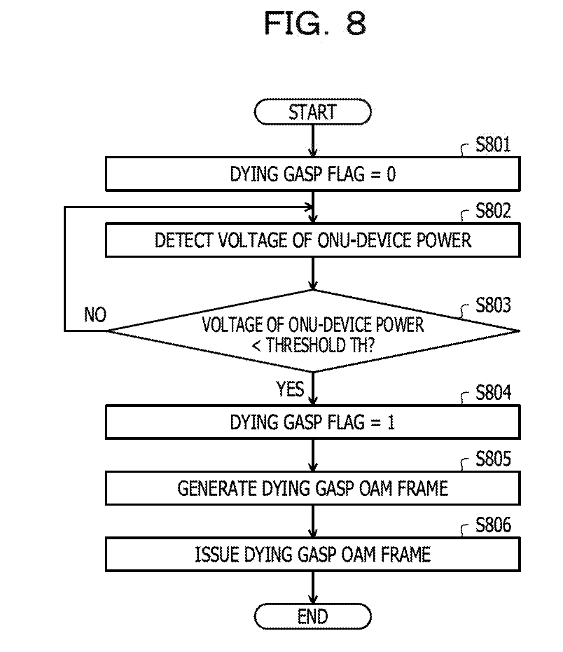

FIG. 8 is a flowchart illustrating an example of processing of issuing a dying gasp OAM frame performed by the ONU device according to the embodiment. The ONU device 110 according to the embodiment executes, for example, steps illustrated in FIG. 8, as the processing of issuing the dying gasp OAM frame.

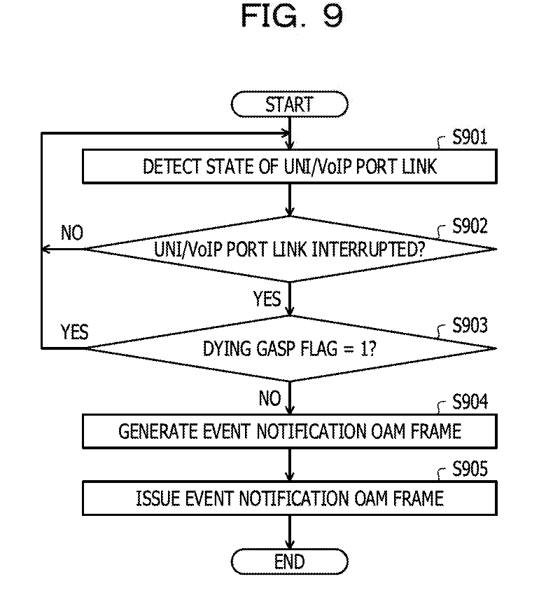

First, the ONU device 110 sets an initial value of a dying gasp flag at “0” (S801). The dying gasp flag is flag information indicating whether to transmit a dying gasp OAM frame. The dying gasp flag is flag information that may be referred to, also in processing of issuing an event notification OAM frame to be described later (see FIG. 9). For example, the MAC_LSI 208 executes S801. The dying gasp flag is stored in, for example, a memory (for example, the flag-information storage section 412) included in the MAC_LSI 208.

Next, the ONU device 110 detects a voltage of the ONU-device power (S802). For example, the voltage monitoring LSI 207 executes S802. Subsequently, the ONU device 110 determines whether the voltage of the ONU-device power detected in S802 falls below the threshold TH (S803). For example, the voltage monitoring LSI 207 or the MAC_LSI 208 executes S803.

When, the voltage of the ONU-device power is not below the threshold TH in S803 (S803: No), the ONU device 110 returns to S802. When the voltage of the ONU-device power falls below the threshold TH (S803: Yes), the ONU device 110 sets the dying gasp flag at “1” (S804). For example, the MAC_LSI 208 executes S804.

The ONU device 110 generates a dying gasp OAM frame for notification of an interruption of the ONU-device power (S805). For example, the MAC_LSI 208 executes S801. Next, the ONU device 110 issues the dying gasp OAM frame generated in S805, to the PON interface card 131 (S806). This ends a series of steps in the processing. For example, the MAC_LSI 208 and the PON optical module 209 execute S806.

In S806, the ONU device 110 stores, for example, the dying gasp OAM frame into the uplink signal buffer 405. The ONU device 110 then reads the dying gasp OAM frame stored in the uplink signal buffer 405 at a time specified by the PON interface card 131, and issues the read dying gasp OAM frame by using an optical signal.

When storing the dying gasp OAM frame into the uplink signal buffer 405, the ONU device 110 may perform processing of discarding an event notification OAM frame in the uplink signal buffer 405. In other words, when an event notification OAM frame is stored in the uplink signal buffer 405 at that point in time, the ONU device 110 may discard the event notification OAM frame being stored.

This may avoid transmission of an event notification OAM frame for notification of a port-link interruption that occurs before occurrence of an interruption of the ONU-device power. Therefore, missing of a dying gasp OAM frame, which may occur due to prohibition of transmission of the dying gasp OAM frame during a waiting time for transmission of an event notification OAM frame, may be avoided.

FIG. 9 is a flowchart illustrating an example of processing of issuing an event notification OAM frame performed by the ONU device according to the embodiment. The ONU device 110 according to the embodiment executes, for example, steps illustrated in FIG. 9, as the processing of issuing the event notification OAM frame. The ONU device 110 executes the processing of issuing the event notification OAM frame illustrated in FIG. 9, in parallel with the processing of the dying gasp OAM frame illustrated in FIG. 8.

First, the ONU device 110 detects a state of each of a UNI port link in the UNI_PHY_LSI 203 and a VoIP port link in the VoIP_PHY_LSI 204 (S901). For example, the MAC_LSI 208 executes S901.

Next, based on a result of the detection in S901, the ONU device 110 determines whether at least one of the UNI port link and the VoIP port link is interrupted (S902). For example, the MAC_LSI 208 executes S902. When none of the UNI port link and the VoIP port link is interrupted (S902: No), the ONU device 110 returns to S901.

When at least one of the UNI port link and the VoIP port link is interrupted in S902 (S902: Yes), the ONU device 110 determines whether a dying gasp flag is “1” (S903). The dying gasp flag is the flag information set by the processing of issuing the dying gasp OAM frame illustrated in FIG. 8. For example, the MAC_LSI 208 executes S903.

When the dying gasp flag is “1” in S903 (S903: Yes), the ONU device 110 may determine that the dying gasp OAM frame is to be transmitted or the dying gasp OAM frame has been transmitted. In this case, the ONU device 110 returns to S901, without issuing an event notification OAM frame to the PON interface card 131.

When the dying gasp flag is not “1” in S903 (S903: No), the ONU device 110 may determine that the dying gasp OAM frame is not to be transmitted. In this case, the ONU device 110 generates an event notification OAM frame for notification of an interruption in at least one of the UNI port link and the VoIP port link (S904). For example, the MAC_LSI 208 executes S904.

Next, the ONU device 110 issues the event notification OAM frame generated in S904, to the PON interface card 131 (S905). This ends a series of steps in the processing. For example, the MAC_LSI 208 and the PON optical module 209 execute S905.

In S905, for example, the ONU device 110 stores the event notification OAM frame into the uplink signal buffer 405. The ONU device 110 then reads the event notification OAM frame stored in the uplink signal buffer 405 at a time specified by the PON interface card 131, and issues the read event notification OAM frame by using an optical signal.

FIG. 10 is a diagram illustrating an example of an OAM frame transmitted by the ONU device according to the embodiment. The ONU device 110 according to the embodiment transmits, for example, an OAM frame 1000 illustrated in FIG. 10, to the PON interface card 131.

A field 1001 (Destination Address) of the OAM frame 1000 is a 6-octet region indicating a destination address (for example, an address of the PON interface card 131) of the OAM frame 1000. A field 1002 (Source Address) of the OAM frame 1000 is a 6-octet region indicating a source address (for example, an address of the ONU device 110) of the OAM frame 1000.

A field 1003 (Type) of the OAM frame 1000 is a 2-octet region indicating a type of the OAM frame 1000. For example, a value of the field 1003 is “0x88-09” indicating a slow protocol.

A field 1004 (Subtype) of the OAM frame 1000 is a 1-octet region indicating a subtype of the OAM frame 1000. For example, a value of the field 1004 is “0x03” indicating OAM.

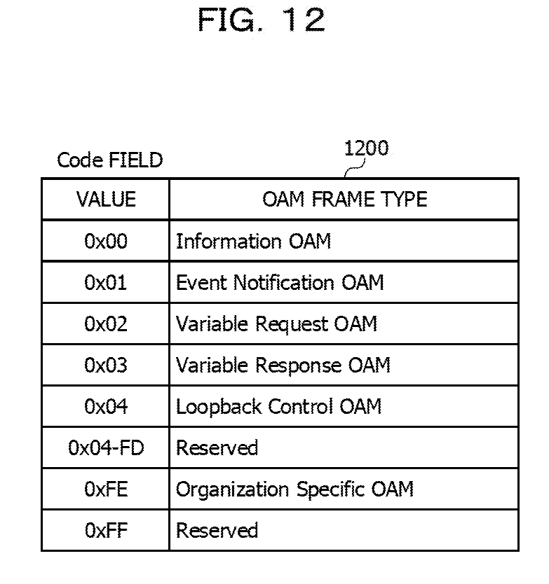

A field 1005 (Flags) of the OAM frame 1000 is a 2-octet region of flag information that may be set in the OAM frame 1000. The field 1005 (Flags) will be described later (with referent to FIG. 11, for example). A field 1006 (Code) of the OAM frame 1000 is a 1-octet region indicating the type of the OAM frame 1000. The field 1006 (Code) Will be described later (with reference to FIG. 12, for example).

A field 1007 (Data/Padding) of the OAM frame 1000 is a 42-to-1496-octet region for data or padding to be transmitted by the OAM frame 1000. A field 1008 (FCS) of the OAM frame 1000 is a 4-octet region indicating Frame Check Sequence (FCS) of the OAM frame 1000.

FIG. 11 is a diagram illustrating an example of a Flags field of an OAM frame transmitted by the ONU device according to the embodiment. The field 1005 (Flags) of the OAM frame 1000 illustrated in FIG. 10 may be, for example, a field 1005 illustrated in FIG. 11. For example, the OAM frame 1000 may be provided as the above-described dying gasp OAM for notification of the interruption of the ONU-device power, by setting “1” as a value of a bit region 1101 (Dying Gasp) of the field 1005 illustrated in FIG. 11.

FIG. 12 is a diagram illustrating an example of a Code field of an OAM frame transmitted by the ONU device according to the embodiment. The field 1006 (Code) of the OAM frame 1000 illustrated in FIG. 10 may take, for example, values indicated in a table 1200 in FIG. 12. For example, when transmitting the OAM frame 1000 as the above-described dying gasp OAM frame, the ONU device 110 assumes the value of the field 1006 (Code) to be “0x00” (Information OAM). This allows the OAM frame 1000 to be the dying gasp OAM frame (Information OAM).

When transmitting the OAM frame 1000 as the above-described event notification OAM frame, the ONU device 110 assumes the value of the field 1006 (Code) to be “0x01” (Event Notification OAM). This allows the OAM frame 1000 to be the event notification OAM frame.

There will be described a reduction in load of the OAM queue 515 in the communication system 100 according to the embodiment. Here, the PON interface card 131 (#1), which contains the 512 ONU devices 110 (#1 to #512) as illustrated in FIG. 1, will be described.

Assume that interruptions of the ONU-device power simultaneously occur in the 512 ONU devices 110 (#1 to #512) due to a cause such as a local massive power outage, and the ONU devices 110 (#1 to #512) each transmit a dying gasp OAM frame to the PON interface card 131 (#1) four times. Furthermore, assume that the ONU devices 110 (#1 to #512) each transmit two event notification OAM frames for notification of a UNI-port-link interruption and a VoIP-port-link interruption to the PON interface card 131.

In a related technique, the total number of OAM frames to be received by the PON interface card 131 is 3,072, that is, (the number of dying gasp OAM frames)+(the number of event notification OAM frames)=(512*4)+(512*2)=3,072.

In contrast, in the communication system 100 according to the embodiment, the total number of OAM frames to be received by the PON interface card 131 is 2,048, that is, (the number of dying gasp OAM frames)=(512*4)=2,048. Therefore, in the communication system 100 according to the embodiment, the total number of OAM frames to be received by the PON interface card 131 may be reduced by approximately 33 [%], as compared with the related technique.

This may suppress an overflow of OAM frames in the OAM queue 515 without increasing the capacity of the OAM queue 515, and thereby avoid missing of a dying gasp OAM frame having high priority.

In this way, in the communication device according to the embodiment, when an interruption of power supplied to the communication device itself and an interruption of communication by a first communication interface are both detected, of information indicating the interruption of the power and information indicating the interruption of the communication, the information indicating the interruption of the power may be transmitted via a second interface. For example, when an interruption of power supplied to the communication device itself is detected, information indicating the interruption of the power may be transmitted without transmission of information indicating an interruption of communication even when the interruption of the communication is detected. Therefore, even when power interruptions simultaneously occur in a large number of communication devices, transmission of information indicating an interruption of communication may be suppressed, and missing of information indicating a power interruption in a predetermined communication device may be avoided.

For example, when detecting an interruption of the ONU power, the ONU device 110 may transmit a dying gasp OAM frame to a predetermined communication device, without transmitting an event notification OAM frame even when a port-link interruption is detected. The predetermined communication device is, for example, the PON interface card 131. This may suppress transmission of event notification OAM frames that are excessive information, even when interruptions of the ONU power simultaneously occur in the large number of ONU devices 110 due to a cause such as a local power outage. Therefore, missing of a dying gasp OAM frame due to an overflow in the OAM queue 515 of the PON interface card 131 may be avoided.

As described above, according to the communication device, the communication system, and the communication method, missing of information indicating a power interruption may be avoided even when power interruptions occur in a large number of communication devices.

For example, according to existing techniques, processing of issuing an event notification OAM frame for notification of an interruption of ONU power and processing of issuing a dying gasp OAM frame for notification of a UNI-port-link interruption or a VoIP-port-link interruption are performed independently. Therefore, when interruptions of the ONU power occur in a plurality of ONUs due to a cause such as a local power outage, a large number of event notification OAM frames, in addition to a dying gasp OAM frame, are transmitted at a burst to an OLT. For this reason, an overflow of OAM frames occurs in the OLT, and the dying gasp OAM frame may be missed in some cases.

It is conceivable that a dying gasp OAM frame may be issued together with an event notification OAM frame. In this case, however, issuing the dying gasp OAM frame may be held back until the event notification OAM frame is generated. Therefore, a power interruption may occur while a MAC_LSI of an ONU is still unable to issue the dying gasp OAM frame.

In contrast, in the ONU device 110 according to the embodiment described above, the processing of issuing the dying gasp OAM frame and the processing of issuing the event notification OAM frame may be linked, as illustrated in FIGS. 8 and 9. In other words, the ONU device 110 may avoid issuing the event notification OAM frame, when issuing the dying gasp OAM frame.

This may avoid transmission of a large number of event notification OAM frames to the OLT device 130 at a burst, even when interruptions of the ONU power occur in the plurality of ONU devices 110 due to a cause such as a local power outage. Therefore, occurrence of an overflow of OAM frames in the OLT device 130 may be suppressed, and missing of the dying gasp OAM frame may be thereby avoided.

According to the ONU device 110, the dying gasp OAM frame may be issued without waiting for generation of the event notification OAM frame. Accordingly, occurrence of a power interruption while the MAC_LSI 208 of the ONU device 110 is still unable to issue the dying gasp OAM frame may be avoided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device, comprising:
a communication circuit configured to transmit, when detecting an interruption of communication performed via a first communication interface, information indicating the interruption of the communication, via a second communication interface; and
a protection circuit configured to supply power to the communication circuit, when an interruption of power to be supplied to the communication circuit is detected, wherein,
when the interruption of the power is detected, the communication circuit transmits information indicating the interruption of the power via the second communication interface, by using the power supplied from the protection circuit, and
when the interruption of the power and the interruption of the communication are both detected, the communication circuit transmits the information indicating the interruption of the power, of the information indicating the interruption of the communication and the information indicating the interruption of the power, via the second communication interface.

2. The communication device according to claim 1, wherein
the communication device is an optical communication device on a subscriber side in a passive optical network, and
the second communication interface is a communication interface with an optical communication device on a central office side in the passive optical network.

3. The communication device according to claim 1,
wherein the communication circuit detects the interruption of the communication by detecting an interruption of signal input from the first communication interface.

4. The communication device according to claim 1,
wherein the interruption of the communication occurs due to a stop of operation of the first communication interface that is caused by the interruption of the power.

5. The communication device according to claim 4, further comprising:
a first power circuit configured to receive power from a commercial power supply; and
a second power circuit connected between the first power circuit and the first communication interface, and configured to receive power from the first power circuit and to supply the power to the first communication interface, wherein
the interruption of the communication occurs due to a stop of the operation of the first communication interface that is caused by a stop of the second power circuit, due to a stop of the first power circuit caused by the interruption of the power.

6. The communication device according to claim 5, further comprising:
a third power circuit connected between the first power circuit and the protection circuit, and configured to receive power from the first power circuit and to supply the power to the protection circuit,
wherein the power supplied from the protection circuit to the communication device stops after the interruption of the communication occurs.

7. A communication method executed by a communication device that includes a communication circuit configured to transmit, when detecting an interruption of communication performed via a first communication interface, information indicating the interruption of the communication, via a second communication interface, and a protection circuit configured to supply power to the communication circuit, when an interruption of power to be supplied to the communication circuit is detected, the communication method comprising:
transmitting, when the interruption of the power is detected, information indicating the interruption of the power via the second communication interface, by using the power supplied from the protection circuit; and
transmitting, when the interruption of the power and the interruption of the communication are both detected, the information indicating the interruption of the power, of the information indicating the interruption of the communication and the information indicating the interruption of the power, via the second communication interface.

8. The communication method according to claim 7, wherein
the communication device is an optical communication device on a subscriber side in a passive optical network, and
the second communication interface is a communication interface with an optical communication device on a central office side in the passive optical network.

9. The communication method according to claim 7,
wherein the communication circuit detects the interruption of the communication by detecting an interruption of signal input from the first communication interface.

10. The communication method according to claim 7,
wherein the interruption of the communication occurs due to a stop of operation of the first communication interface that is caused by the interruption of the power.

11. A communication system comprising:
a plurality of first communication devices; and
a second communication device coupled to the plurality of first communication devices,
wherein the first communication devices respectively include:
a communication circuit configured to transmit, when detecting an interruption of communication performed via a first communication interface, information indicating the interruption of the communication, via a second communication interface to the second communication device, and
a protection circuit configured to supply power to the communication circuit, when an interruption of power to be supplied to the communication circuit is detected,
wherein the communication circuit is configured to:
transmit, when the interruption of the power is detected, information indicating the interruption of the power via the second communication interface to the second communication device, by using the power supplied from the protection circuit, and
transmit, when the interruption of the power and the interruption of the communication are both detected, the information indicating the interruption of the power, of the information indicating the interruption of the communication and the information indicating the interruption of the power, via the second communication interface to the second communication device, and
wherein the second communication device is configured to:
receive the information indicating the interruption of the communication and the information indicating the interruption of the power transmitted from the communication circuit, and
output the received information.

12. The communication system according to claim 11, wherein
the communication device is an optical communication device on a subscriber side in a passive optical network, and
the second communication interface is a communication interface with an optical communication device on a central office side in the passive optical network.

13. The communication system according to claim 11,
wherein the communication circuit detects the interruption of the communication by detecting an interruption of signal input from the first communication interface.

14. The communication system according to claim 11,
wherein the interruption of the communication occurs due to a stop of operation of the first communication interface that is caused by the interruption of the power.
